(19) United States
(12) Patent Application Publication
(10) Pub. No.: US 2012/0236173 A1
(43) Pub. Date: Sep. 20, 2012

(54) DIGITAL CAMERA USER INTERFACE WHICH ADAPTS TO ENVIRONMENTAL CONDITIONS

(76) Inventors: Michael J. Telek, Pittsford, NY (US); Marc N. Gudell, Penfield, NY (US); Kenneth Alan Parulski, Rochester, NY (US)

(21) Appl. No.: 13/049,934

(22) Filed: Mar. 17, 2011

(51) Int. Cl. H04N 9/73; H04N 5/225

(52) U.S. Cl. 348/223.1; 348/231.99; 348/E09.051; 348/E05.024

(57) ABSTRACT

A digital camera having a user interface that automatically adapts to its environment, comprising: an image sensor for capturing a digital image; an optical system for forming an image of a scene onto the image sensor; one or more environmental sensors; a configurable user interface; a data processing system; a storage memory for storing captured images; and a program memory communicatively connected to the data processing system and storing instructions configured to cause the data processing system to implement a method for adaptively configuring the user interface. The stored instructions include: sensing one or more environmental attributes using the environmental sensors; automatically configuring at least one user control element of the user interface in response to the one or more sensed environmental attributes without any user intervention; capturing a digital image of a scene using the image sensor; and storing the captured digital image in the storage memory.

### CROSS-REFERENCE TO RELATED APPLICATIONS

Reference is made to commonly-assigned, co-pending U.S. patent application Ser. No. 12/711,452 (Docket 95974), filed Feb. 24, 2010, entitled “Portable imaging device having display with improved visibility under adverse conditions,” by Hahn et al., to commonly assigned, co-pending U.S. patent application Ser. No. 12/728,486 (Docket 96112), filed Mar. 22, 2010, entitled: “Underwater camera with pressure sensor,” by Parulski et al., and to commonly assigned, co-pending U.S. patent application Ser. No. 12/728,511 (Docket 96113), filed Mar. 22, 2010, entitled: “Digital camera with underwater capture mode,” by Madden et al., each of which is incorporated herein by reference.

### FIELD OF THE INVENTION

This invention pertains to the field of digital cameras, and more particularly to a digital camera having a user interface that automatically adapts to environmental conditions.

### BACKGROUND OF THE INVENTION

Digital cameras typically include a graphic user interface (GUI) to enable various camera modes and features to be selected. In some digital cameras, a touch-screen color LCD display is used to display various control elements which can be selected by a user in order to modify the camera mode or select various camera features.

It is desirable to use different camera features and modes for different situations and environmental conditions. Selecting an appropriate camera mode can be problematic for a user, especially when the user would like to immediately capture an image. For example, the user may be capturing images outdoors on a snowy day, for example while skiing. In this case, the photographer may want to select a “snow scene” camera mode setting. But this can require that the user make appropriate selections from multiple level menus, which can be a difficult task when the user is wearing gloves, for example.

While most digital cameras provide a standard set of features to all users, it is known to provide two different user interfaces for two different users of the same digital camera, as described in commonly-assigned U.S. Pat. No. 6,903,762, entitled “Customizing a digital camera for a plurality of user” by Prabhu, et al, which is incorporated herein by reference. This patent discloses that when the digital camera is powered on, the user selects their name from a list of users displayed on the image display. A processor in the digital camera then uses the appropriate stored firmware components or settings to provide a customized camera GUI and feature set for that particular user. Alternatively, when the digital camera is powered on, the settings for the last user can be employed, and a camera preferences menu can be used to select a different user.

There remains a need to simplify the user interface for selecting features and modes provided by digital cameras in order to provide an improved usability under various environmental situations.

### SUMMARY OF THE INVENTION

The present invention represents a digital camera having a user interface that automatically adapts to its environment, comprising:

an image sensor for capturing a digital image;

an optical system for forming an image of a scene onto the image sensor;

one or more environmental sensors;

a configurable user interface;

a data processing system;

a storage memory for storing captured images; and a program memory communicatively connected to the data processing system and storing instructions configured to cause the data processing system to implement a method for adaptively configuring the user interface, wherein the instructions include:
sensing one or more environmental attributes using the environmental sensors;
automatically configuring at least one user control element of the user interface in response to the one or more sensed environmental attributes without any user intervention;
capturing a digital image of a scene using the image sensor; and
storing the captured digital image in the storage memory.

The present invention has the advantage that the user interface of the digital camera automatically adapts to the environmental conditions without the need for any user intervention.

It has the additional advantage that the set of options that are presented to the user can be limited to those that are appropriate in the current environmental conditions.

It has the further advantage that the appearance and configuration of the user interface can be automatically adjusted to improve the visibility and usability of the user control elements.

### BRIEF DESCRIPTION OF THE DRAWINGS

FIG. 1 is a high-level diagram showing the components of a digital camera system;

FIG. 2 is a flow diagram depicting typical image processing operations used to process digital images in a digital camera;

FIG. 3 is a diagram illustrating one embodiment of a digital camera according to the present invention;

FIG. 4 is a flowchart showing steps for providing a user interface on a digital camera that automatically adapts to its environment;

FIG. 5A is a table listing examples of environmental condition categories in accordance with the present invention;

FIG. 5B is a table listing examples of camera modes appropriate for various environmental condition categories;

FIG. 6A depicts a first example user interface configuration appropriate for use in a normal environmental condition;

FIG. 6B depicts a second example user interface configuration appropriate for use in an underwater environmental condition;

FIG. 6C depicts a third example user interface configuration appropriate for used in an underwater environmental condition;

FIG. 6D depicts a fourth example user interface configuration appropriate for used in an underwater environmental condition which uses tactile user controls;

FIG. 6E depicts a fifth example user interface configuration appropriate for use in a cold environmental condition;

FIG. 6F depicts a sixth example user interface configuration appropriate for use in a bright environmental condition; and

FIG. 6G depicts a seventh example user interface configuration appropriate for use in a dark environmental condition.

It is to be understood that the attached drawings are for purposes of illustrating the concepts of the invention and may not be to scale.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

The following description of a digital camera will be familiar to one skilled in the art. It will be obvious that there are many variations of this embodiment that are possible and are selected to reduce the cost, add features or improve the performance of the camera.

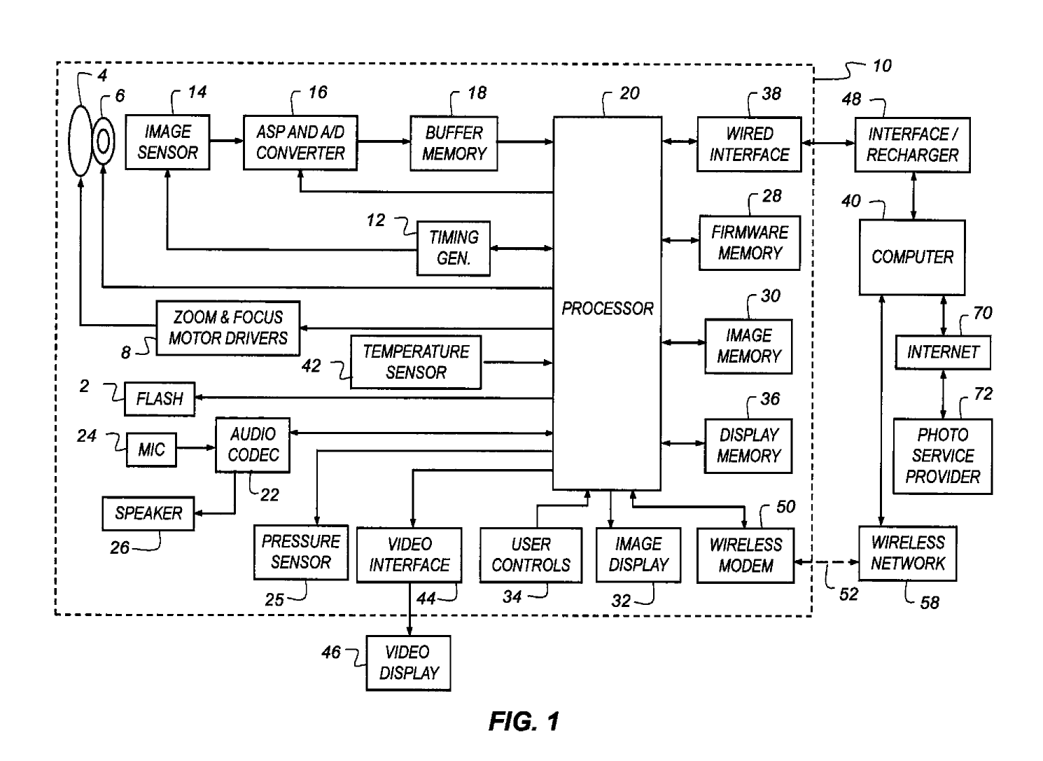

FIG. 1 depicts a block diagram of a digital photography system, including a digital camera 10. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens and is controlled by zoom and focus motor drives 8. The lens 4 focuses light from a scene (not shown) onto an image sensor 14, for example, a single-chip color CCD or CMOS image sensor. The lens 4 is one type optical system for forming an image of the scene on the image sensor 14. In other embodiments, the optical system may use a fixed focal length lens with either variable or fixed focus.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned U.S. Patent Application Publication 2007/0024934, filed on Feb. 1, 2007, and titled “Image sensor with improved light sensitivity” to Compton and Hamilton, the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene. In some embodiments of the present invention, the flash 2 has an adjustable correlated color temperature. For example, the flash disclosed in U.S. Patent Application Publication 2008/0297027 to Miller et al., entitled “Lamp with adjustable color,” can be used to produce illumination having different color balances for different environmental conditions, such as having a higher proportion of red light when the digital camera 10 is operated underwater.

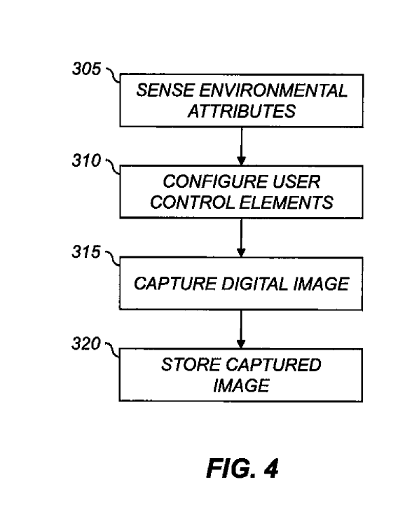

The lens 4 of the digital camera 10 can be focused in the first mode by using “through-the-lens” autofocus, as described in commonly-assigned U.S. Pat. No. 5,668,597, entitled “Electronic Camera with Rapid Automatic Focus of an Image upon a Progressive Scan Image Sensor” to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance can be stored as metadata in the image file, along with other lens and camera settings. The focus distance can also be used to determine an approximate subject distance, which can be used to automatically configure one or more user control elements of the user interface, as will be described later in reference to FIG. 4. In some embodiments, a separate subject distance sensor can be used to determine the approximate distance between the digital camera 10 and the main subject of the scene to be captured.

In some embodiments, the image sensor 14 can also be used to determine the ambient light level. In other embodiments, an auxiliary sensor (not shown) can be used to measure an illumination level of the scene to be photographed.

A pressure sensor 25 on the digital camera 10 can be used to sense the pressure on the exterior of the digital camera 10. The pressure sensor 25 can serve as an underwater sensor to determine whether the digital camera 10 is being used underwater. Underwater digital cameras with pressure sensors can operate as described in commonly assigned U.S. patent application Ser. No. 12/728,486 (docket 96112), filed Mar. 22, 2010 entitled: “Underwater camera with pressure sensor”, by Parulski et al., which is incorporated herein by reference. According to this invention, the sensed pressure is used to determine if the camera is being operated underwater and to select an underwater photography mode or a normal photography mode accordingly. The digital image images are processed according to the selected photography mode. In addition, it is taught that the behavior of various user controls (e.g., buttons and menus) can be set to behave differently in the underwater mode.

In an alternative embodiment, a moisture sensor can be used in place of, or in addition to, the pressure sensor 25 in order to determine whether the digital camera 10 is being used underwater, or is being used in a rainy environment. In yet another alternate embodiment, the image sensor 14 can be used as the underwater sensor. In this case, the image sensor 14 can be used to capture a preliminary image of the scene, which can then be analyzed to determine whether the digital camera 10 is being used underwater. For example, the preliminary image of the scene can be analyzed to determine a color balance. Images captured underwater will generally have a distinctive bluish color cast. Therefore, if the determined color balance is consistent with an underwater color cast, it can be assumed that the digital camera is being operated underwater.

A temperature sensor 42 is used for sensing the ambient temperature surrounding the digital camera 10. Temperature sensors are well-known in the art. For example, the temperature sensor 42 can be a silicon bandgap temperature sensor, such as the LM35 precision centigrade temperature sensor available from National Semiconductor, Santa Clara, Calif.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 includes various user control elements which can be selected by user controls 34. The user control elements are configured by the processor 20 responsive to one or more sensed environmental attributes, such as temperature, light level, or pressure, as will be described later.

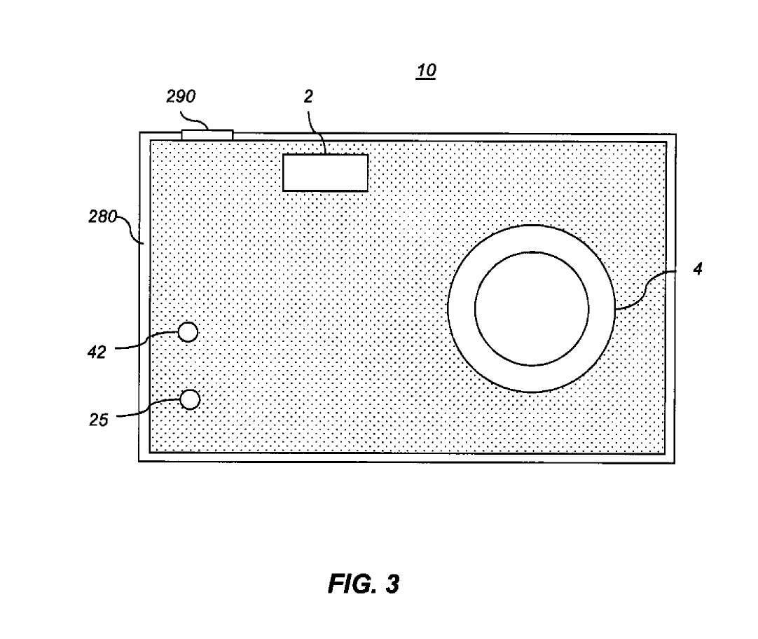

The user controls 34 are used to select various camera modes, such as video capture mode, still capture mode, and review mode, and to initiate capture of still images and recording of motion images. In some embodiments, the first mode described above (i.e. still preview mode) is initiated when the user partially depresses a shutter button (e.g., image capture button 290 shown in FIG. 3), which is one of the user controls 34, and the second mode (i.e., still image capture mode) is initiated when the user fully depresses the shutter button. The user controls 34 are also used to turn on the camera, control the lens 4, and initiate the picture taking process. User controls 34 typically include some combination of buttons, rocker switches, joysticks, or rotary dials. In some embodiments, some of the user controls 34 are provided by using a touch screen overlay on the image display 32 having one or more touch-sensitive user control elements.

Various camera modes, such as assorted flash photography modes, a self-timer mode, a high-dynamic range (HDR) mode, and a night landscape mode, can be selected by a user of the digital camera 10, by using some of the user controls 34. According to embodiments of the present invention, one or more user control elements associated with the user controls 34 (e.g., buttons or menu entries displayed on the image display 32) are configured in response to sensed environmental conditions, as will be described later. These environmental conditions can include, for example, a “normal” condition, an “underwater” condition, a “very cold” condition, a “very bright” condition, and a “very dark” condition.

According to some embodiments, the number of user control elements in a menu of different choices, as well as the size, shape, color, and appearance of the user control elements, can be adjusted according to the environmental conditions. In this way, the user of the digital camera 10 can more easily select camera modes and features that are of interest in the current environment. For example, when the camera is being used under “very cold” conditions, the number of user control elements can be reduced, and the size of the user control elements can be enlarged, so that the user can more easily select modes even while wearing gloves. Accordingly, if the user controls 34 are provided using a touch screen overlay, the touch resolution can be adjusted so that it is less sensitive to the exact finger placement of the user. In some embodiments, some of the user controls 34 are provided using a touch-screen that overlays the image display 32 and uses microfluidic technology to create various physical buttons. The size and position of the physical buttons can be modified responsive to different environmental conditions.

An audio codec 22 connected to the processor 20 receives an audio signal from a microphone 24 and provides an audio signal to a speaker 26. These components can be to record and playback an audio track, along with a video sequence or still image. If the digital camera 10 is a multi-function device such as a combination camera and mobile phone, the microphone 24 and the speaker 26 can be used for telephone conversation. In some embodiments, microphone 24 is capable of recording sounds in air and also in an underwater environment when the digital camera 10 is used to record underwater images according to the method of the present invention. In other embodiments, the digital camera 10 includes both a conventional air microphone as well as an underwater microphone (hydrophone) capable of recording underwater sounds.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

In some embodiments, the digital camera 10 is a water proof digital camera capable of being used to capture digital images underwater and under other challenging environmental conditions, such as in rain or snow conditions. For example, the digital camera 10 can be used by scuba divers exploring a coral reef or by children playing at a beach. To prevent damage to the various camera components, the digital camera 10 includes a watertight housing 280 (FIG. 3).

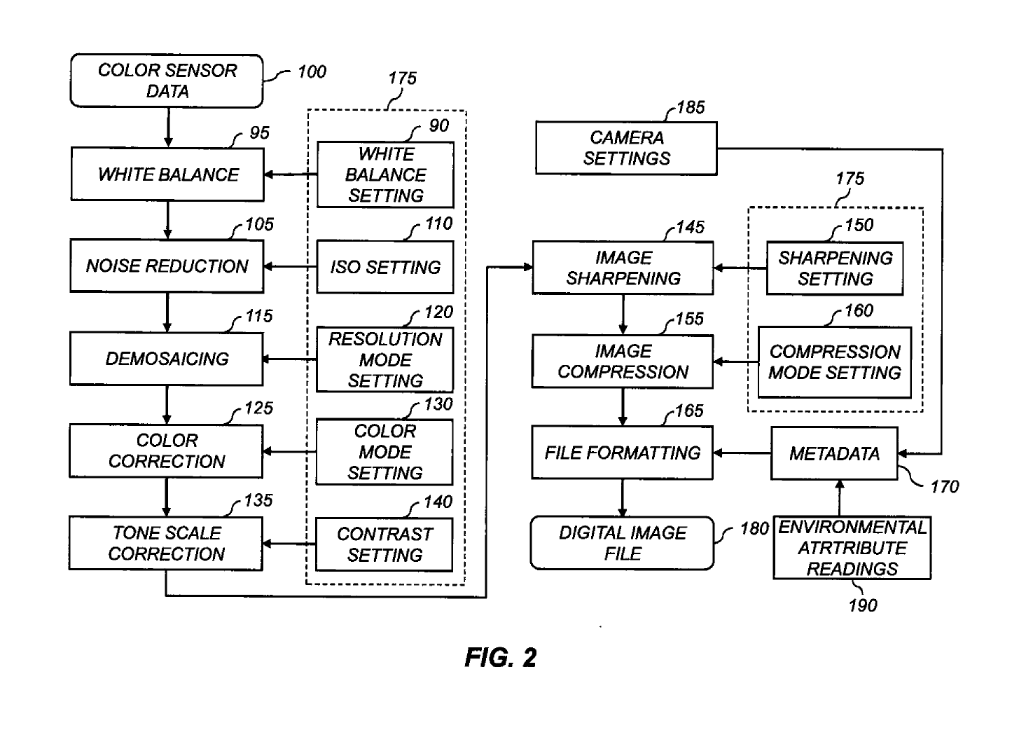

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various user settings 175, which can be selected via the user controls 34 in response to menus displayed on the image display 32. In a preferred embodiment, the user control elements available in the menus are adjusted responsive to sensed environmental conditions.

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Mild, entitled “White balance adjustment device and color identification device”, the disclosure of which is herein incorporated by reference. The white balance can be adjusted in response to a white balance setting 90, which can be manually set by a user, or can be automatically set to different values when the camera is used in different environmental conditions, as will be described later in reference to FIG. 4.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting. The level of noise reduction can also be adjusted differently for different environmental conditions, as will be described later in reference to FIG. 4

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et al., the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal”, to Cok, the disclosure of which is herein incorporated by reference.

In some embodiments, the user can select between different pixel resolution modes, so that the digital camera can produce a smaller size image file. Multiple pixel resolutions can be provided as described in commonly-assigned U.S. Pat. No. 5,493,335, entitled “Single sensor color camera with user selectable image record size,” to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

### Setting 1 (Normal Color Reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{in} \\ {G}_{in} \\ {B}_{in}\end{matrix} ] \qquad ( 1 )$$

### Setting 2 (Saturated Color Reproduction)

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{in} \\ {G}_{in} \\ {B}_{in}\end{matrix} ] \qquad ( 2 )$$

### Setting 3 (De-Saturated Color Reproduction)

$$[ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{in} \\ {G}_{in} \\ {B}_{in}\end{matrix} ] \qquad ( 3 )$$

### Setting 4 (Monochrome)

$$[ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{in} \\ {G}_{in} \\ {B}_{in}\end{matrix} ] \qquad ( 4 )$$

### Setting 5 (Nominal Underwater Color Reproduction)

$$[ \begin{matrix}{R}_{out} \\ {G}_{out} \\ {B}_{out}\end{matrix} ] = [ \begin{matrix}3.00 & - 0.30 & - 0.20 \\ - 0.80 & 1.80 & - 0.40 \\ - 0.40 & - 0.20 & 1.40\end{matrix} ] [ \begin{matrix}{R}_{in} \\ {G}_{in} \\ {B}_{in}\end{matrix} ] \qquad ( 3 )$$

As described in commonly assigned U.S. patent application Ser. No. 12/728,511 (docket 96113), filed Mar. 22, 2010, entitled: “Digital camera with underwater capture mode”, by Madden et al which is incorporated herein by reference, underwater images tend to have a reduced signal level in the red color channel. The color reproduction matrix in Eq. (5) represents a combination of the normal color reproduction matrix of Eq. (1), with a gain factor of 2× applied to the red input color signal Rᵢₙ. This provides an improved color reproduction for a nominal underwater environment where the amount of red light in a captured image is reduced by a factor of 50%.

In other embodiments, a three-dimensional lookup table can be used to perform the color correction step 125. In some embodiments, different 3×3 matrix coefficients, or a different three-dimensional lookup table, are used to provide color correction when the camera is in the underwater mode, as will be described later in reference to FIG. 4.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135. In some embodiments, a high contrast tone scale correction curve is used when the camera is in the underwater condition, and a low contrast tone scale correction curve is used when the camera is used in a low temperature, high light level environmental condition corresponding to a “sun on snow” condition.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10. In some embodiments, different image sharpening algorithms can be manually or automatically selected, depending on the environmental condition. The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format. In a preferred embodiment of the present invention, the metadata 170 includes information about camera settings 185, including an environmental condition category, such as “underwater”, as well as the environmental attribute readings 190 (such as the ambient pressure, ambient temperature, and ambient light level).

FIG. 3 is a diagram showing the front of the digital camera 10. The digital camera 10 includes watertight housing 280 to enable operating the digital camera 10 in an underwater environment. Watertight housings 280 are generally rated to be watertight down to a certain maximum depth. Below this depth the water pressure may be so large that the watertight housing 280 will start to leak. The digital camera 10 also includes lens 4, temperature sensor 42, pressure sensor 25, and image capture button 290, which is one of the user controls 34 in FIG. 1. The lens 4 focuses light onto the image sensor 14 (shown in FIG. 1) in order to determine the ambient light level. Optionally, the digital camera 10 can include other elements such as flash 2.

The pressure sensor 25 returns a signal indicating the pressure outside the watertight housing 280. The pressure P as a function of depth in a fluid is given by:

P=P₀+ρgd_{C} (6)

where P₀ is the air pressure at the upper surface of the fluid, ρ is the fluid density (˜1000 kg/m³), g is the acceleration due to gravity (˜9.8 m/s²) and d_{C} is the camera depth.

Preferably, the pressure sensor 25 is calibrated to return the “gauge pressure” P_{G}, which is the pressure difference relative to the air pressure:

When the digital camera 10 is operated in air, the gauge pressure P_{G} will be approximately equal to zero. When the digital camera 10 is operated in the water, the gauge pressure P_{G} will be greater than zero. Therefore, the detected pressure provided by the pressure sensor 25 can be used to determine whether the digital camera 10 is being operated in the water or the air by performing the test:

if P_{G}<ε then

Camera in Air

else

Camera Underwater (8)

where ε is a small constant which is selected to account for the normal variations in atmospheric pressure. The pressure detected by the pressure sensor 25 can be used to control the color correction applied to digital images captured by the digital camera 10, as well as to control other aspects of the operation of the digital camera 10. In some embodiments, the color correction can also be controlled responsive to the tilt angle of the camera and the object distance.

A method for providing a user interface on a digital camera 10 that automatically adapts to its environment will now be described with reference to FIG. 4. The digital camera 10 of FIGS. 1 and 3 includes a pressure sensor 25 adapted to sense the pressure on the outside surface of the watertight housing 280, as well as a temperature sensor 42 adapted to sense the temperature of the air or water on the outside surface of the watertight housing 280. The digital camera 10 also includes a lens 4 and an image sensor 14 which can be used to sense the ambient light level. The ambient light level can be determined by capturing a preliminary image of the scene using the image sensor 14, and analyzing the preliminary image to estimate the ambient light level

A sense environmental attributes step 305 is used to sense one or more environmental attributes, using one or more environmental sensors. The environmental attributes can include an ambient temperature sensed by the temperature sensor 42, an ambient pressure sensed by the pressure sensor 25, or an ambient light level sensed by the image sensor 14 or some other ambient light sensor. It will be obvious that other environmental attributes can also be sensed and used in accordance with the present invention.

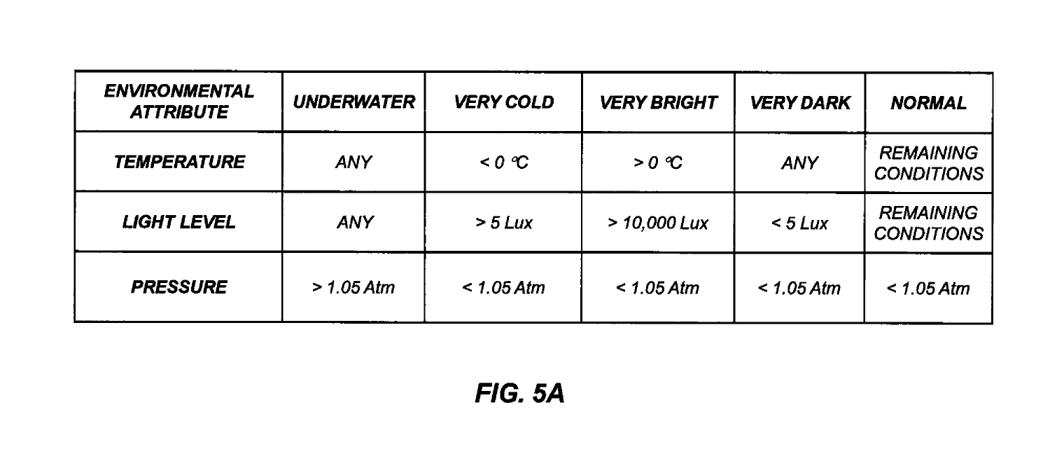

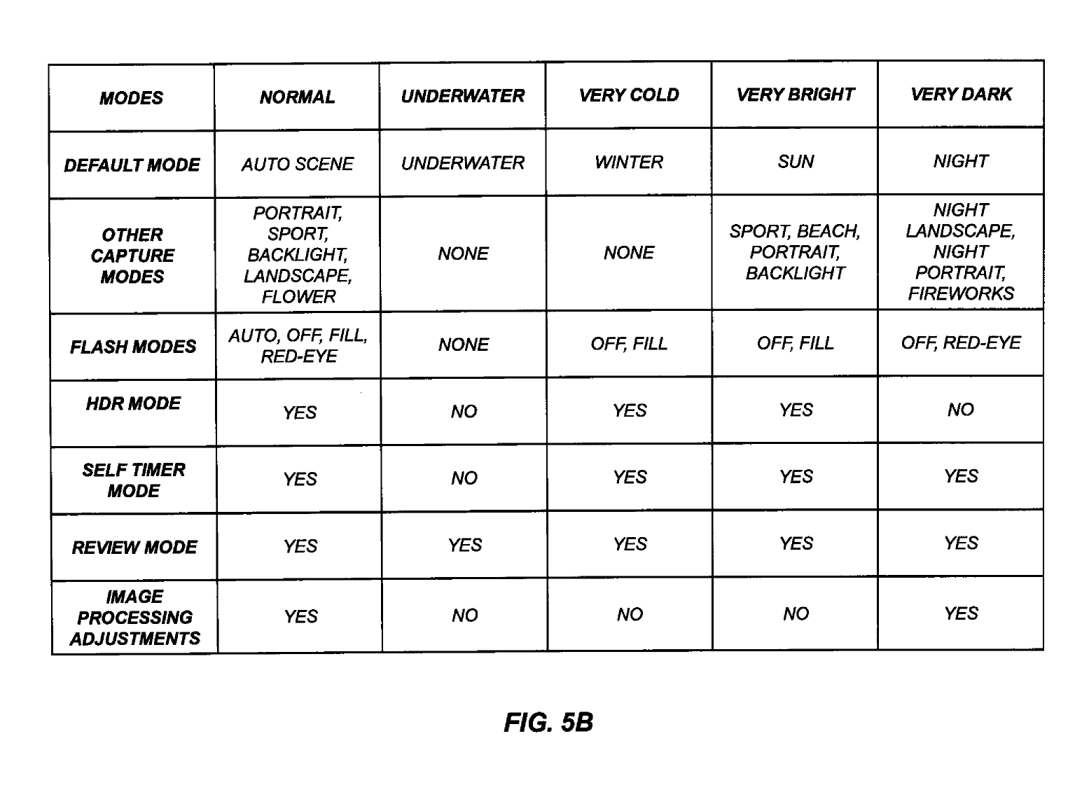

The values of the environmental attributes can be used to categorize the environmental conditions according a plurality of predefined environmental condition categories. FIG. 5A shows a representative example of how the ambient temperature, ambient light level, and ambient pressure environmental attributes can be used to categorize the environmental conditions according to five different environmental condition categories. It will be understood that many other types of environmental condition categories could be used, rather than the five listed in FIG. 5A.

The five environmental condition categories shown in the example of FIG. 5A include an “underwater” environmental condition category, which is selected whenever the ambient pressure reading is greater than 1.05 Atmospheres (Atm). The value of 1.05 Atm corresponds to a water depth of approximately 0.5 meters, where 0.05 Atm is a safety factor chosen so that the camera is very unlikely to switch to the “underwater” user interface mode, due to engineering tolerances, when it is above water.

The five environmental condition categories shown in FIG. 5A also include a “very cold” environmental condition category, which is selected when the pressure is less than 1.05 Atm and the temperature is less than 0° C.

The five environmental condition categories shown in FIG. 5A also include a “very bright” environmental condition category, which is selected when the pressure is less than 1.05 Atm, the temperature is greater than 0° C., and the ambient light level is greater than 10,000 Lux.

The five environmental condition categories shown in FIG. 5A also include a “very dark” environmental condition category, which is selected when the pressure is less than 1.05 Atm, and the ambient light level is less than 5 Lux.

The five environmental condition categories shown in FIG. 5A also include a “normal” condition, which is used in all other cases.

Returning to a discussion of FIG. 4, a configure user control elements step 310 is used to automatically configure one or more user control elements of the user interface in response to the sensed environmental attributes. Commonly-assigned, co-pending U.S. patent application Ser. No. 12/711,452 (Docket 95974) to Hahn et al., entitled “Portable imaging device having display with improved visibility under adverse conditions,” which is incorporated herein by reference, discloses a digital camera which automatically selects one of a plurality of preview color enhancement transforms responsive to an environmental sensor such as an ambient light level sensor. This approach can be used to improve the visibility of the display under bright sunlight conditions. But it does not disclose configuring the user control elements of the user interface.

In some embodiments, the configuration of the one or more user control elements is accomplished by changing the number, type, size, shape, color, order, position, or appearance of the user control elements displayed on the image display 32 of the digital camera 10. For example, the number and type of user control elements used when the environmental attributes fall within the five different environmental condition categories listed in FIG. 5A can be automatically configured as shown in the table of FIG. 5B, which shows example sets of user-selectable modes that are appropriate in the five different environmental condition categories.

In FIG. 5B, the “normal” column shows an example of the features that are provided by the user interface of the digital camera 10 in the “normal” environmental conditions. Under these environmental conditions, the user can select from many settings typically offered by digital cameras. The default mode is the “auto scene” mode, which is the normal default mode for digital cameras. When the “normal” environmental conditions are detected, the processor 20 automatically sets the camera to the “auto scene” mode. The user control elements of the user interface are configured to allow the user to select between other optional modes, for example, various flash modes, an HDR (high dynamic range) mode, a self-timer mode, and a review mode. The user can also adjust various settings associated with image processing steps, such as the user settings 175 described with respect to FIG. 2.

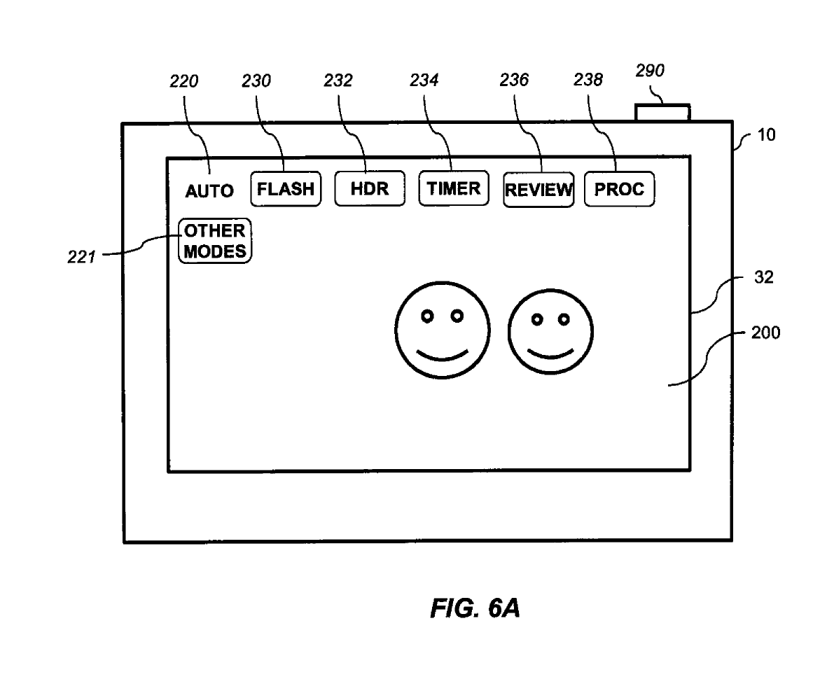

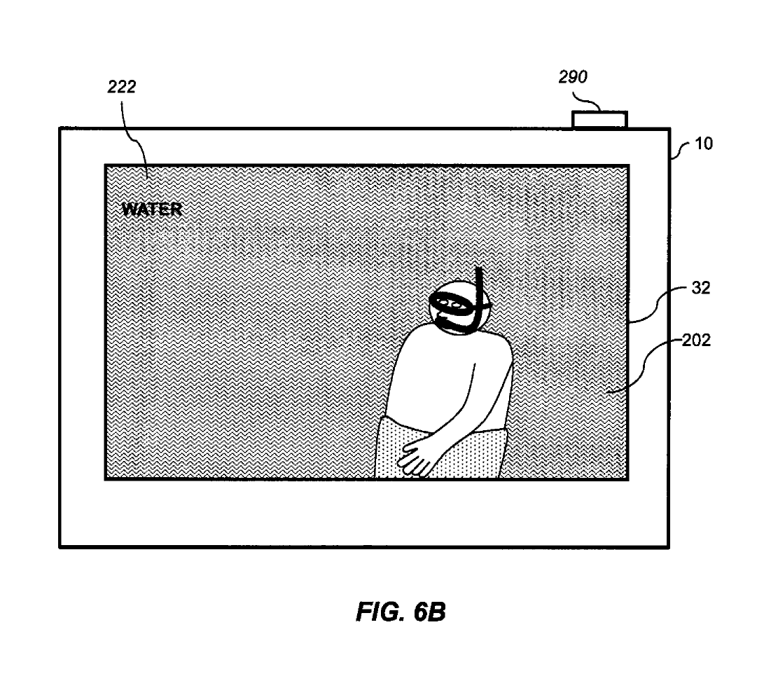

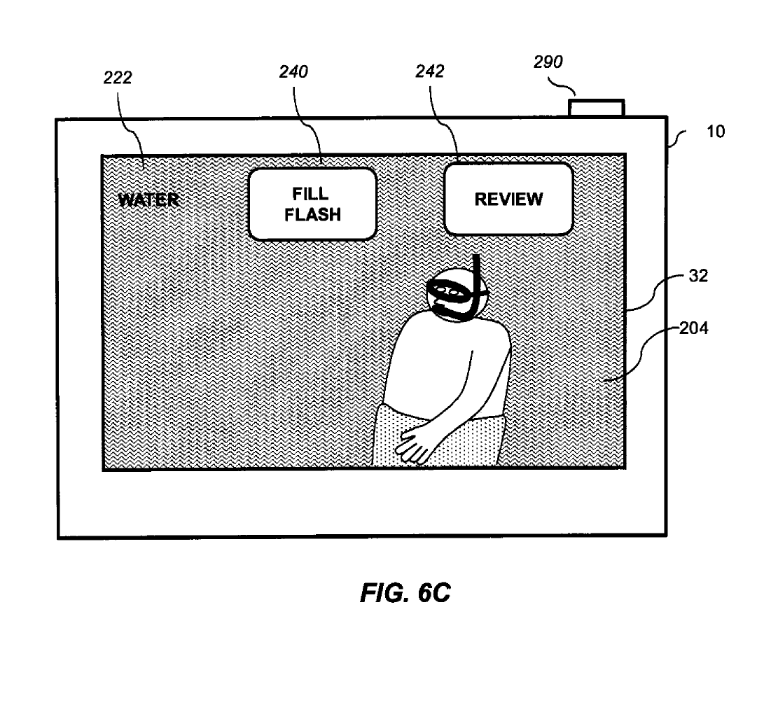

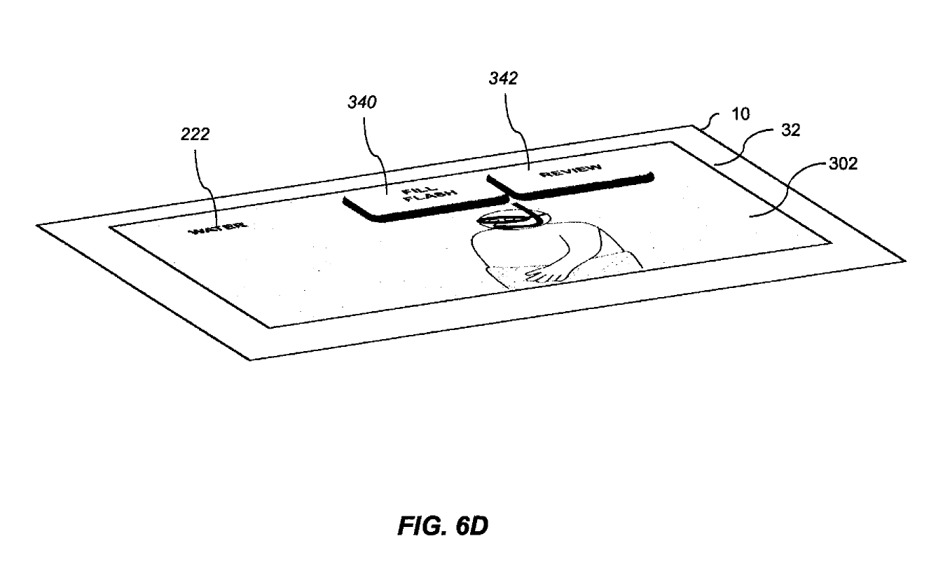

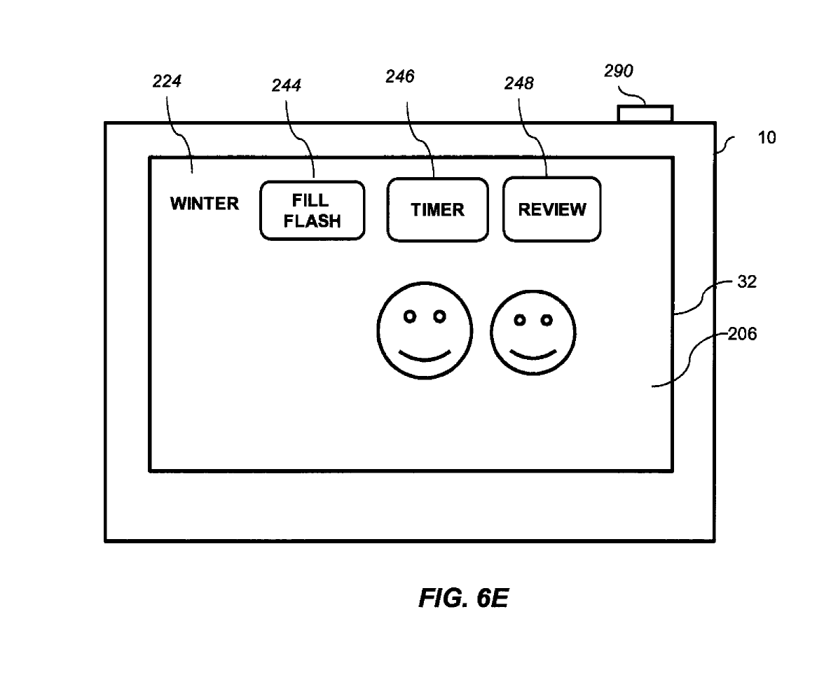

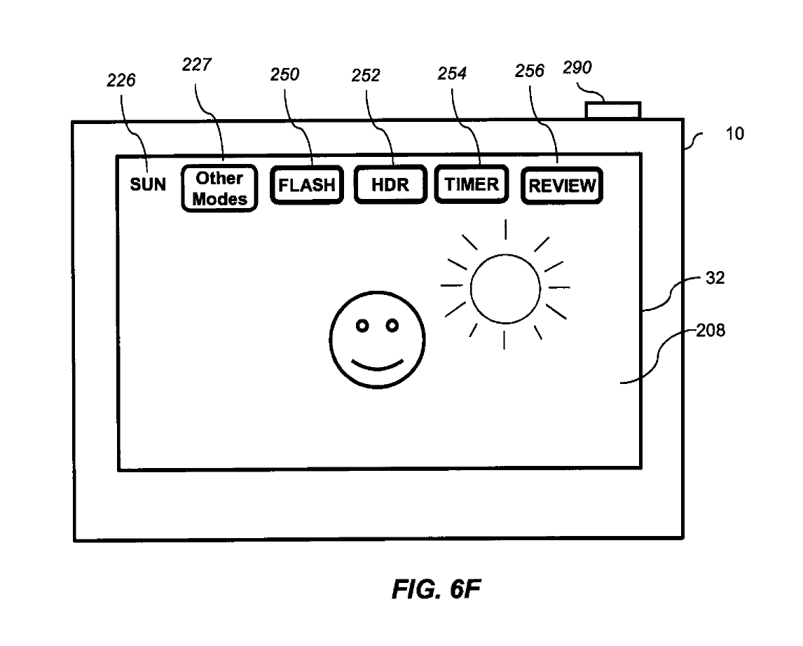

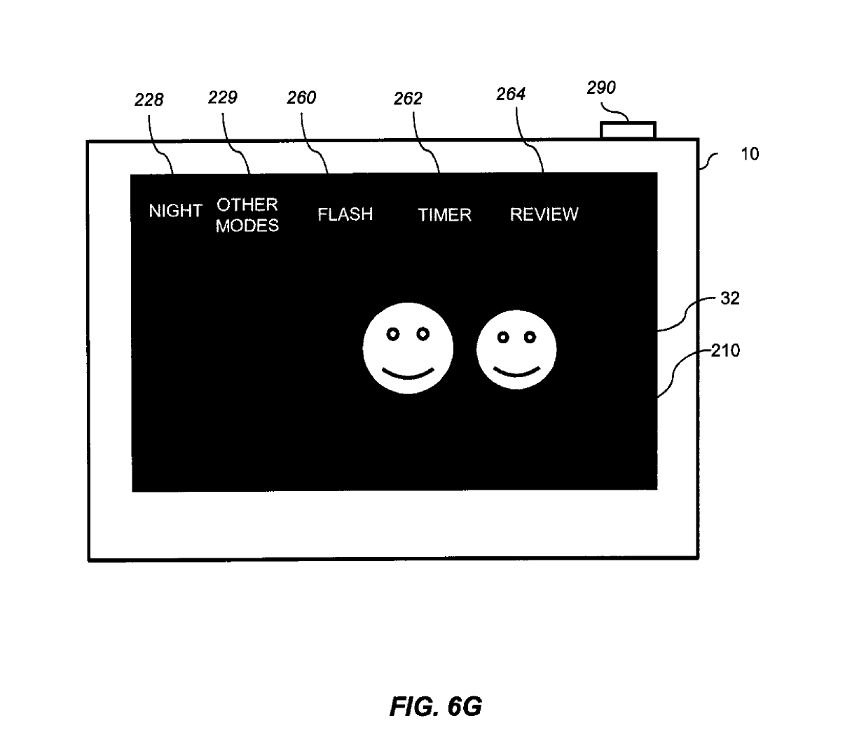

FIG. 6A shows a first example of a top-level user interface screen 200 displayed on the image display 32 of the digital camera 10 for the “normal” environmental condition. The user interface screen 200 shows a preview of the scene to be captured, overlaid with a series of user interface icons corresponding to various user interface options. The user interface icons include a set of relatively small icons including a flash mode icon 230, an HDR mode icon 232, a timer mode icon 234, a review mode icon 236 and an image processing adjustments icon 238 which can be selected by the user of the digital camera 10, for example by touching the image display 32, if a touch-screen user interface is used. The user interface screen 200 also displays a current mode icon 220 which indicates that the current capture mode is the automatic scene capture mode.

An other modes icon 221 is also provided that can be selected to bring up a second-level user interface screen (not shown) that enables the user to select one of the “other capture modes” listed in FIG. 5A for the “normal” environmental condition.

When the user of the digital camera 10 selects the flash mode icon 230 a second-level user interface screen (not shown) is displayed that allows the user to select a particular flash mode. For the configuration of FIG. 5A, the flash modes that can be selected using the second-level user interface screen include an “auto flash” mode, a “flash off” mode, a “fill flash” mode, and a “red-eye flash” mode.

The user of the digital camera 10 can select the HDR icon 232 to select the high dynamic range mode. Similarly, the user of the digital camera 10 can select the timer mode icon 234 in order to select the self-timer mode. The user of the digital camera 10 can select the review mode icon 236 in order to select the review mode, so that previously captured digital images are displayed on the image display 32. When the user of the digital camera 10 selects the image processing adjustments icon 238 a second-level user interface screen (not shown) is displayed that enables the user of the digital camera 10 to adjust the user settings 175 described earlier in reference to FIG. 2.

FIG. 6B shows a second example of a top-level user interface screen 202 displayed on the image display 32 of the digital camera 10 for the case where the sensed environmental attributes are determined to correspond to the “underwater” environmental condition category. Since the digital camera 10 is being used underwater, the user interface screen 202 does not include the various small user interface icons shown in FIG. 6A for the “normal” environmental condition category. The user interface screen 202 is configured this way for several reasons. First, it may be difficult for the user of the digital camera 10 to select small icons while swimming underwater. Second, many of the modes provided for use in a normal environment are not appropriate for underwater photography. For example, the HDR mode would not be appropriate since the underwater environment typically has a limited dynamic range. Finally, if the image display 32 includes a pressure sensitive touch screen user interface, the user interface may not operate properly underwater, since the pressure of the water may interfere with the pressure-sensing operation. Therefore, it is appropriate to deactivate any touch-sensitive user control elements when the digital camera is being operated underwater.

The user interface screen 202 displays a current mode icon 222 which indicates that the current capture mode is the underwater capture mode. A preview image of the scene to be captured is also displayed as part of the user interface screen 202.

FIG. 6C shows a third example of a top-level user interface screen 204 displayed on the image display 32 of the digital camera 10. The user interface screen 204 represents an alternate embodiment of a user interface that is appropriate for the case where the sensed environmental attributes are determined to correspond to the “underwater” environmental condition category. In this case, user interface screen 204 includes several touch screen icons. In order to provide a touch screen display which operates in underwater environments, the digital camera 10 may utilize micro fluidic technology to create transparent physical buttons which overlay the image display 32 and serve as the touch screen user interface.

Since the digital camera 10 is being used underwater, the user interface screen 204 does not include all of the small icons shown in FIG. 6A for the “normal” environment. Rather, it includes a smaller number of larger touch screen icons corresponding to the camera modes that are most likely to be useful in the underwater environment. The larger icons can be more easily selected by the user of the digital camera 10 while in the underwater environment. A fill flash mode icon 240 is used to set the flash mode to “fill flash”, and a review mode icon 242 is used to select the review mode, so that previously captured digital images are displayed on the image display 32.

The user interface screen 204 also displays the current mode icon 222, which indicates that the current capture mode is the underwater capture mode. A preview image of the scene to be captured is also displayed as part of the user interface screen 204.

Some types of touch sensitive user interface screens (e.g., capacitive touch screens, which work by sensing a conductive connection with a finger) are not effective for use in an underwater environment. FIG. 6D shows a variation of the example shown in FIG. 6C appropriate for the case where the sensed environmental attributes are determined to correspond to the “underwater” environmental condition category. The configuration of FIG. 6D is identical to that of FIG. 6C except that it utilizes a tactile user interface screen 302, which includes one or more tactile user controls. The tactile user controls introduce a physical structure to the surface of the tactile user interface screen 302 which can be sensed by touch and can be activated by pressing with a finger. In this example, the tactile user interface screen 302 includes a raised fill flash mode icon 340 and a raised review mode icon 342. When the digital camera 10 is used in an underwater environment, the tactile user interface screen 302 is adjusted by altering the physical structure of the surface so that the raised fill flash mode icon 340 and the raised review mode icon 342 are raised from the surface so that they can more easily be located and activated by a user.

Any method known in the art for forming tactile user controls on a touch sensitive user interface screen can be used in accordance with the present invention. U.S. Patent Application Publication 2009/0174673 to Ciesla, entitled “System and methods for raised touch screens,” teaches a touch-sensitive user interface screen that uses microfluidics to produce raised buttons. The arrangements of raised buttons can be adaptively controlled by using a pump to inject a fluid into a cavity to deform a particular surface region in order to “inflate” a button thereby providing a tactile user control. Similarly, the fluid can be pumped out of the cavity to “deflate” the button when it is not needed. According to various embodiments, the physical structure of the user interface screen is adaptively controlled to provide one or more tactile user controls in response to one or more sensed environmental attributes. A touch-sensitive layer is provided to sense activation of the raised buttons.

FIG. 6E shows a fifth example of a top-level user interface screen 206 for the case where the sensed environmental attributes are determined to correspond to the “very cold” (e.g., winter) environmental condition category. In this environment, the user of the digital camera 10 may be wearing gloves or mittens. In order to provide a more appropriate user interface in the very cold environment, the user interface screen 206 does not include all of the small icons shown in FIG. 6A for the “normal” environment. Rather, it includes a smaller number of medium-sized icons corresponding to the camera modes that are most likely to be useful in the very cold environment. The medium-sized icons can be more easily selected by the user of the digital camera 10 while wearing gloves. A fill flash mode icon 244 is used to select the fill flash mode, a timer mode icon 246 is used to select the self timer mode, and a review mode icon 248 is used to select the review mode.

The user interface screen 204 also displays a current mode icon 224, which indicates that the current capture mode is the “winter” capture mode. A preview image of the scene to be captured is also displayed as part of the user interface screen 206.

FIG. 6F shows a sixth example of a top-level user interface screen 208 displayed on the image display 32 of the digital camera 10 for the case where the sensed environmental attributes are determined to correspond to the “very bright” environmental condition category. The user interface screen 208 includes a group of relatively small but very high contrast icons that can be selected by the user of the digital camera 10, for example by touching the image display 32, if a touch-screen user interface is used. The contrast of the icons is adjusted relative to the configuration of FIG. 6A in order to be more visible under bright sunlight conditions. The icons include an other modes icon 227, a flash mode icon 250, an HDR mode icon 252, a timer mode icon 254 and a review mode icon 256. The user interface screen 208 also displays a current mode icon 226 which indicates that the current capture mode is the “sun” capture mode. A preview image of the scene to be captured is also displayed as part of the user interface screen 208. It will be understood that the icons displayed user on the interface screen 208 may be the same size as the icons shown in FIG. 6A that are designed for use with the “normal” environmental condition category, but may have a higher contrast, bolder look in order to be more visible under bright sunny conditions.

The user of the digital camera 10 can select the other modes icon 227 in order to change the capture mode to one of the other capture modes listed in FIG. 5B for the “very bright” environmental condition category using a second-level user interface screen (not shown). The user of the digital camera 10 can select the flash mode icon 250 in order to adjust the flash modes using a second-level user interface screen (not shown). It will be understood that the flash modes that can be selected, using the second-level user interface, in the very bright environmental condition may be different than those used in the “normal” environmental condition, as listed in FIG. 5B. For example, the red-eye flash mode is not useful in the very bright environmental condition.

The user of the digital camera 10 can select the HDR mode icon 252 in order to select the high dynamic range mode. Similarly, the user of the digital camera 10 can select the timer mode icon 254 in order to select the self-timer mode. The user of the digital camera 10 can select the review mode icon 256 in order to select the review mode, so that previously captured digital images are displayed on the image display 32.

FIG. 6G shows a seventh example of a top-level user interface screen 210 displayed on the image display 32 of the digital camera 10 for the case where the sensed environmental attributes are determined to correspond to the “very dark” (e.g., night) environmental condition category. The user interface screen 210 includes a group of relatively small and lower contrast icons that can be selected by the user of the digital camera 10, for example by touching the image display 32, if a touch-screen user interface is used. The icons are designed to be more appropriate for viewing under dark viewing conditions, for example by having a reduced contrast range. The icons include an other modes icon 229, a flash mode icon 260, a timer mode icon 262 and a review mode icon 264. The user interface screen 210 also displays a current mode icon 228 which indicates that the current capture mode is the “night” capture mode. A preview image of the scene to be captured is also displayed as part of the user interface screen 210. It will be understood that the icons displayed on the user interface screen 210 may be the same size as the icons shown in FIG. 6A that are designed for use with the “normal” environmental condition category, but may have a lower contrast or brightness, or use different colors, graphics, or type fonts, in order to be more appropriate under night viewing conditions.

The user of the digital camera 10 can select the other modes icon 229 in order to change the capture mode to one of the other capture modes listed in FIG. 5B for the “very dark” environmental condition category, using a second-level user interface screen (not shown). The user of the digital camera 10 can select the flash mode icon 260 in order to adjust the flash modes using a second-level user interface screen (not shown) to select one of flash modes listed in FIG. 5B for the “very dark” environmental condition category. The user of the digital camera 10 can select the timer mode icon 262 in order to select the self-timer mode. Similarly, the user of the digital camera 10 can select the review mode icon 264 in order to select the review mode, so that previously captured digital images are displayed on the image display 32. It will be understood from the foregoing description that the size, number, shape, color, order, position, font, and appearance of the user interface elements displayed on the image display 32 can be modified, responsive to the sensed environmental conditions, in order to provide a user interface which adapts to the environmental conditions without any user intervention. This can be done so that the set of available menu options that can be selected by a user of the digital camera 10 is modified responsive to the sensed environmental conditions. If the user interface is provided used a touch sensitive softcopy display, the resolution of the touch screen can be modified, responsive to the sensed environmental conditions.

Returning to a discussion of FIG. 4, a capture digital image step 315 is used to capture a digital image of the scene using the image sensor 14. The digital camera 10 has an image capture button 290 (FIGS. 3, and 6A-6G) to allow the photographer to initiate capturing a digital image. In some embodiments, alternate means for initiating image capture can be provided such as a touch screen user control, a timer mechanism or a remote control.

The processor 20 (FIG. 1) in the digital camera 10 captures the digital image of the scene using the mode(s) selected by the user of the digital camera 10 using the configured user control elements. It will be understood that the processor 20 can automatically adjust other camera settings when capturing the digital image responsive to the sensed environmental conditions. For example, the amplification and frequency response of the audio codec 22 can also be adjusted according to whether the digital camera 10 is being operated in an underwater condition, a nighttime condition, or a normal condition.

It will also be understood that various aspects of the processing path shown in FIG. 2 can be adjusted responsive to the sensed environmental attributes. For example, different white balance settings 90, color mode settings 130, contrast settings 140, and sharpening settings 150 can be used depending on the sensed environmental conditions. For example, digital images captured underwater tend to be reproduced with a cyan color cast if normal color processing is applied. The color mode settings 130 used the color correction step 125 and the contrast settings 140 used by the tone scale correction step 135 (FIG. 2) can be adjusted to used settings that are designed to remove the cyan color cast when it is determined that the digital camera 10 is operating in the underwater condition.

In some embodiments, a single normal color transform is provided for use whenever the digital camera 10 is not in the underwater condition. In alternate embodiments, a variety of color transforms can be provided that are automatically selected according to the sensed environmental conditions or according to manual user controls 34.

Returning to a discussion of FIG. 4, a store captured image step 320 is used to store the processed digital image in a digital image file 180 as described earlier in reference to FIG. 2. In one embodiment of the present invention, the digital camera 10 is a digital still camera, and the digital image file 180 is stored using a standard digital image file format such as the well-known EXIF file format. In embodiments where the digital camera 10 provides digital image data for a video sequence, the digital image file 180 can be stored using a standard digital video file format such as the well-known H.264 (MPEG-4) video file format.

Standard digital image file formats and digital video file formats generally support storing various pieces of metadata 170 (FIG. 2) together with the digital image file 180. For example, metadata 170 can be stored indicating pieces of information such as image capture time, lens focal length, lens aperture setting, shutter speed and various user settings. In a preferred embodiment of the present invention, the digital camera 10 also stores metadata 170 which provides the determined environmental condition category (e.g., “underwater”) as well as the individual environmental attribute readings 190. Preferably, this metadata is relating to the environmental conditions stored as metadata tags in the digital image file 180. Alternately, the metadata relating to the environmental conditions can be stored in a separate file associated with the digital image file 180.

In one embodiment, one of the environmental attribute readings 190 is a pressure reading determined using the pressure sensor 25 (FIG. 1) In other embodiments, the environmental attribute readings 190 can include a simple Boolean value indicating whether the sensed pressure was judged to be above the threshold for water pressure.

The metadata 170 relating to the environmental conditions can be used for a variety of purposes. For example, a collection of digital image files 180 can contain some digital images captured underwater, others which were captured on very cold days while skiing, and others which were captured on warm days at the beach. A user may desire to search the collection of digital image files 180 to quickly find the digital images captured underwater, or while skiing, or at the beach. The metadata relating to the environmental conditions provides a convenient means for helping to identify the digital images captured under these conditions. Another example of how the metadata relating to the environmental conditions can be used would be to control the behavior of image processing algorithms applied at a later time on a host computer system. Those skilled in the art will recognize that the metadata relating to the environmental conditions can be used for a variety of other purposes.

In a preferred embodiment of the present invention, the digital camera 10 includes an autofocus system that automatically estimates the object distance and sets the focus of the lens 4 accordingly, as described earlier in reference to FIG. 1. The object distance determined using the autofocus system can then be used to control the user interface elements.

In some embodiments, the digital camera 10 has a flash 2 having an adjustable correlated color temperature as mentioned earlier with respect to FIG. 1. In this case, the color reproduction can be controlled by adjusting the correlated color temperature of the flash illumination when the digital camera 10 is operating in different environmental conditions, such as underwater. For example, a lower correlated color temperature having a higher proportion of red light can be used when the camera is operating under water. This can, at least partially, compensate for the fact that the water absorbs a higher proportion of the red light.

In some embodiments, other environmental attributes can be sensed using an environmental sensor, and used to automatically configure at least one user control element of the user interface in response to the sensed environmental attribute without any user intervention. For example, a subject distance detector can be used to determine the distance between the digital camera 10 and a subject in the scene to be captured. Different user control elements can be automatically configured by the processor 20 in the digital camera 10 depending on the distance. For example, if the distance between the digital camera 10 and the subject is large, the user control elements related to selecting a flash mode can be modified, since for example, red-eye is unlikely to be a problem at distances greater than 10 feet.

In some embodiments, some environmental sensors can be replaced or augmented by using environmental information provided by one or more environmental sensors that are external to the digital camera. In this case, the sensed environmental attributes can be communicated to the digital camera 10 using a wired or wireless connection. For example, if the digital camera 10 is a camera phone that incorporates a Global Positioning System (GPS) receiver, the digital camera 10 can determine its current position. If the GPS information indicates that the digital camera 10 is currently located in a position that corresponds to an outdoor environment, the digital camera can receive weather related data, including a current temperature for this location, from a weather data service provider over the wireless network 58 (FIG. 1).

In an alternate embodiment, the geographical location can be determined by capturing an image of the scene using the image sensor 14 and comparing the captured image to a database of images captured at known geographical locations. For an example of such a method, see the article by Flays et al., entitled “IM2GPS: estimating geographic information from a single image” (IEEE Conference on Computer Vision and Pattern Recognition, pp. 1-8, 2008). In this case, the image sensor 14 serves the purpose of a location sensor.

The invention has been described in detail with particular reference to certain preferred embodiments thereof, but it will be understood that variations and modifications can be effected within the spirit and scope of the invention.

### PARTS LIST (NEED TO UPDATE)

2 flash
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
25 pressure sensor
26 speaker
28 firmware memory
30 image memory
32 image display
34 user controls
36 display memory
38 wired interface
40 computer
42 temperature sensor
44 video interface
46 video display
48 interface/recharger
50 wireless modem
52 radio frequency band
58 wireless network
70 Internet
72 photo service provider
90 white balance setting
95 white balance step
100 color sensor data
105 noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 user settings
180 digital image file
185 camera settings
190 environmental attribute readings
200 user interface screen
202 user interface screen
204 user interface screen
206 user interface screen
208 user interface screen
210 user interface screen
220 current mode icon
221 other modes icon
222 current mode icon
224 current mode icon
226 current mode icon
227 other modes icon
228 current mode icon
229 other modes icon
230 flash mode icon
232 HDR mode icon
234 timer mode icon
236 review mode icon
238 image processing adjustments icon
240 fill flash mode icon
242 review mode icon
244 fill flash mode icon
246 self timer mode icon
248 review mode icon
250 flash mode icon
252 HDR mode icon
254 timer mode icon
256 review mode icon
260 flash mode icon
262 timer mode icon
264 review mode icon
280 watertight housing
290 image capture button
302 tactile user interface screen
305 sense environmental attributes step
310 configure user control elements step
315 capture digital image step
320 store captured image step
340 raised fill flash mode icon
342 raised review mode icon

1. A digital camera having a user interface that automatically adapts to its environment, comprising:
an image sensor for capturing a digital image;
an optical system for forming an image of a scene onto the image sensor;
one or more environmental sensors;
a configurable user interface;
a data processing system;
a storage memory for storing captured images; and
a program memory communicatively connected to the data processing system and storing instructions configured to cause the data processing system to implement a method for adaptively configuring the user interface, wherein the instructions include:
sensing one or more environmental attributes using the environmental sensors;
automatically configuring at least one user control element of the user interface in response to the one or more sensed environmental attributes without any user intervention;
capturing a digital image of a scene using the image sensor; and
storing the captured digital image in the storage memory.

2. The digital camera of claim 1 further including a watertight housing, and wherein one of the environmental sensors in an underwater sensor that senses whether the digital camera system is being operated underwater.

3. The digital camera of claim 2 wherein the underwater sensor is a pressure sensor for sensing the pressure outside the watertight housing.

4. The digital camera of claim 1 wherein one of the environmental sensors is an ambient light sensor that senses an ambient light level.

5. The digital camera of claim 4 wherein the ambient light level is sensed by capturing a preliminary image of the scene using the image sensor, and wherein the preliminary image is analyzed to estimate an ambient light level.

6. The digital camera of claim 1 wherein one of the environmental sensors is a temperature sensor that senses an ambient temperature.

7. The digital camera of claim 1 wherein one of the environmental sensors is a subject distance sensor that senses a distance to a subject in the scene.

8. The digital camera of claim 1 wherein one of the environmental sensors is the image sensor, and wherein one or more of the environmental attributes are determined by analyzing a preliminary image of the scene captured using the image sensor.

9. The digital camera of claim 8 wherein the preliminary image of the scene is analyzed to determine a color balance, and wherein it is determined whether the digital camera is being operated underwater responsive to the determined color balance.

10. The digital camera of claim 1 wherein one or more of the environmental sensors are external environmental sensors that are external to the digital camera, and wherein the corresponding sensed environmental attributes are communicated to the digital camera using a wired or wireless connection.

11. The digital camera of claim 10 wherein the external environmental sensors sense weather related data, and wherein the corresponding sensed environmental attributes are weather related data corresponding to a current geographical location of the digital camera.

12. The digital camera of claim 11 wherein the geographical location of the digital camera is determined using a global positioning system receiver, and wherein the geographical location is transmitted to a system providing the weather related data using a wireless communication network.

13. The digital camera of claim 2 wherein the configurable user interface includes a touch screen having one or more touch-sensitive user control elements, and wherein the touch-sensitive user control elements are deactivated when the digital camera system is sensed to be operating underwater.

14. The digital camera of claim 1 wherein the program memory also stores instructions configured to cause the data processing system to process the captured digital image by applying one or more image processing operations before storing it in the storage memory, and wherein one or more of the image processing operations are adjusted responsive to the one or more sensed environmental attributes.

15. The digital camera of claim 14 the image processing operations are adjusted by adjusting settings associated with the image processing operations.

16. The digital camera of claim 1 wherein the size, shape, color, position, font, or appearance of at least one user control element is modified in response to the one or more sensed environmental attributes.

17. The digital camera of claim 1 wherein a set of available menu options is modified in response to the one or more sensed environmental attributes.

18. The digital camera of claim 1 wherein the number of user control elements included in the user interface is modified in response to the one or more sensed environmental attributes.

19. The digital camera of claim 1 wherein the physical structure one or more user control elements is modified in response to the one or more sensed environmental attributes.

20. The digital camera of claim 19 wherein the physical structure is modified to provide one or more user raised buttons.
